(19) United States
(12) Patent Application Publication
(10) Pub. No.: US 2021/0018745 A1
(43) Pub. Date: Jan. 21, 2021

(54) IMAGING APPARATUS AND IMAGING METHOD

(71) Applicant: NEC Corporation, Tokyo (JP)

(72) Inventor: Chenhui HUANG, Tokyo (JP)

(73) Assignee: NEC Corporation, Tokyo (JP)

(21) Appl. No.: 16/979,774

(22) PCT Filed: Mar. 20, 2019
(86) PCT No.: PCT/JP2019/011722

§ 371 Date: Sep. 10, 2020

(30) Foreign Application Priority Data
Mar. 20, 2018 (JP) 2018-052223

(51) Int. Cl. G02B 23/24; G01N 21/47; H04N 5/369

(52) U.S. Cl. CPC G02B 23/2469; G01N 2021/479; H04N 5/369; G01N 21/4788

(57) ABSTRACT

An imaging apparatus according to an aspect of the present disclosure includes: a waveguide that transmits light emitted from a light source; a detector that detects power of a speckle pattern generated by the light passing through the waveguide and applied to an object; at least one memory storing a set of instructions; and at least one processor configured to execute the set of instructions to reconstruct an image of the object based on the power obtained by making the light enter the waveguide under different conditions.

### TECHNICAL FIELD

The present invention relates to an imaging apparatus and an imaging method.

### BACKGROUND ART

Imaging apparatuses such as small-diameter scopes and image transmission devices have been used in, for example, medical practice, failure inspection of precision equipment, and archaeological investigations requiring low fracture. For example, PTL 1 discloses a technique related to an optical system for automatically imaging a wide-ranging surface area requiring treatment in laser treatment using an endoscope.

Meanwhile, a technique called compressed sensing for restoring an object, such as an image, from observation data smaller than required data is being developed. In the compressed sensing, an algorithm such as an alternating direction method of multipliers (ADMM) algorithm disclosed in NPL 1 is used as an algorithm for restoring an object.

### CITATION LIST

### Patent Literature

[PTL 1] Japanese Unexamined Patent Application No. 2012-098743

### Non Patent Literature

[NPL 1] S. Boyd, N. Parikh, E. Chu et al, Distributed Optimization and Statistical Learning via the Alternating Direction Method of Multipliers, Foundation and Trends in Machine Learning 3, 1-122, 2010.

### SUMMARY OF INVENTION

### Technical Problem

The size of the apparatus used in the application purpose mentioned above may limit the location where imaging can be performed. That is, as compared with the technique disclosed in PTL 1, an imaging apparatus that can be used in a narrower space has been required.

The present invention has been conceived to solve the problem described above, and it is a main object of the present invention to provide an imaging apparatus and the like that can be used in a narrow space.

### Solution to Problem

An imaging apparatus according to one aspect of the present invention includes a waveguide that transmits light generated by a light source, a detector that detects power of a speckle pattern generated by the light passing through the waveguide and applied to an object, and reconstruction means for reconstructing an image of the object on the basis of the power obtained by making the light enter the waveguide under different conditions.

Furthermore, an imaging method according to one aspect of the present invention includes detecting power of a speckle pattern generated by light passing through a waveguide and applied to an object, and reconstructing an image of the object on the basis of the power obtained by making the light enter the waveguide under different conditions.

### Advantageous Effects of Invention

According to the present invention, it becomes possible to provide an imaging apparatus and the like that can be used in a narrow space.

### BRIEF DESCRIPTION OF DRAWINGS

FIG. 1 is a diagram illustrating an imaging apparatus according to an example embodiment of the present invention.

FIG. 2 is a diagram illustrating a detailed exemplary configuration of the imaging apparatus according to the example embodiment of the present invention.

FIG. 3 is a diagram illustrating an exemplary configuration for obtaining a transformation matrix to be used in the imaging apparatus according to the example embodiment of the present invention.

FIG. 4 is a view illustrating an exemplary speckle pattern to be used in the imaging apparatus according to the example embodiment of the present invention.

FIG. 5 is a diagram illustrating a relationship between the transformation matrix and the speckle pattern to be used in the imaging apparatus according to the example embodiment of the present invention.

FIG. 6 is a flowchart illustrating operation of the imaging apparatus according to the example embodiment of the present invention.

FIG. 7 is a diagram illustrating an exemplary imaging apparatus according to a variation of the example embodiment of the present invention.

FIG. 8 is a diagram illustrating another exemplary imaging apparatus according to the variation of the example embodiment of the present invention.

FIG. 9 is a diagram illustrating another exemplary imaging apparatus according to the variation of the example embodiment of the present invention.

FIG. 10 is a diagram illustrating another exemplary imaging apparatus according to the variation of the example embodiment of the present invention.

FIG. 11 is a view illustrating an exemplary image to be reconstructed in a simulation example of the present invention.

### EXAMPLE EMBODIMENT

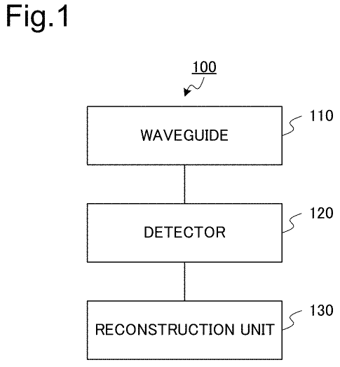

An example embodiment of the present invention will be described with reference to the accompanying drawings. FIG. 1 is a diagram illustrating an imaging apparatus according to the example embodiment of the present invention.

As illustrated in FIG. 1, the imaging apparatus according to the example embodiment of the present invention includes a waveguide 110, a detector 120, and a reconstruction unit 130. The waveguide 110 transmits light. The detector 120 detects power of a speckle pattern generated by the light passing through the waveguide and applied to an object. The reconstruction unit 130 reconstructs an image of the object on the basis of a plurality of pieces of power obtained by emitting light into the waveguide under different conditions.

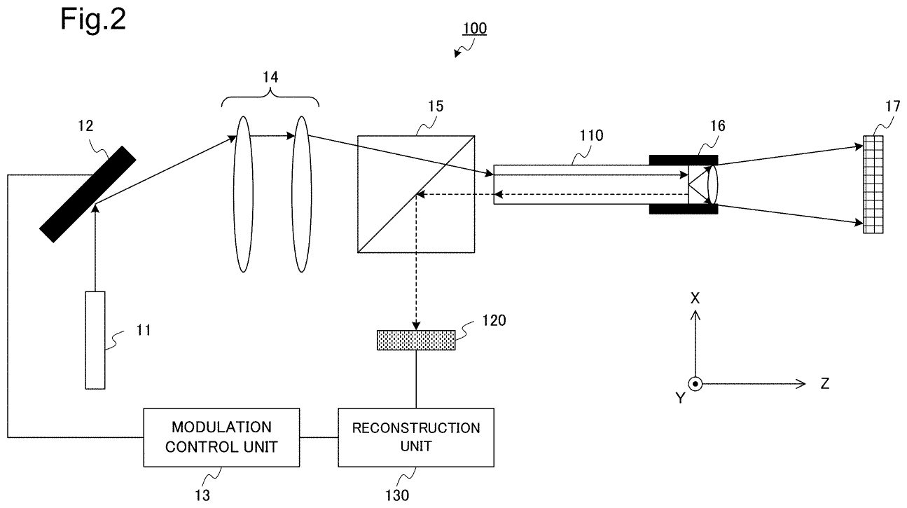

An imaging apparatus 100 has a configuration illustrated in FIG. 2 as a more specific example. In the exemplary configuration illustrated in FIG. 2, the imaging apparatus 100 includes, in addition to each element mentioned above, a light source 11, a modulator 12, a modulation control unit 13, an optical system 14, a beam splitter 15, and a lens probe 16. The imaging apparatus 100 reconstructs an image of a target 17.

In FIG. 2, a solid line arrow indicates a direction in which light generated from the light source 11 travels, and a dotted line arrow indicates a direction in which light reflected from the target 17 travels.

The light source 11 generates light to be applied to the object. In the present example embodiment, the light source 11 primarily generates light of a single wavelength. The modulator 12 modulates the light generated by the light source 11. Modulation of light in the present example embodiment will be described in detail later. The modulation control unit 13 controls a state of modulation by the modulator 12. The light modulated by the modulator 12 passes thorough the appropriately provided optical system 14, and enters the waveguide 110. The beam splitter 15 separates the light to be made incident on the waveguide 110 and applied to the object from the light reflected from the object.

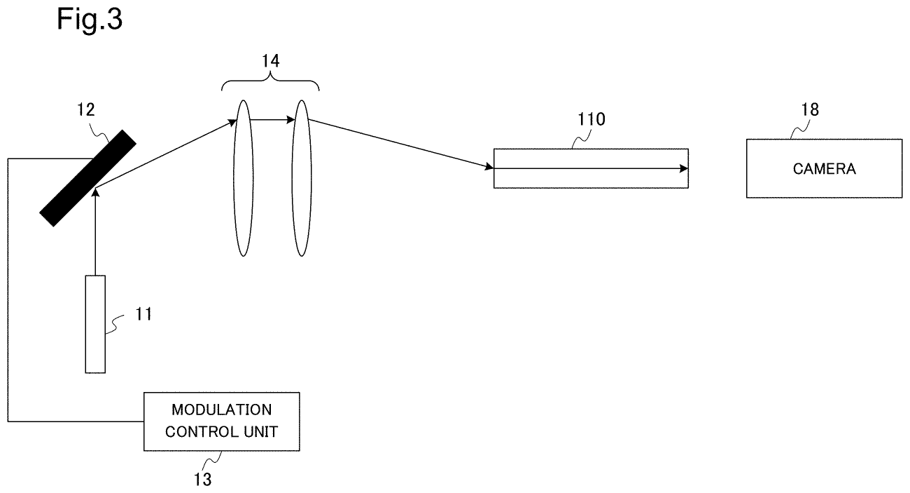

In FIG. 2 and in the example of FIG. 3 to be described later, the light generated by the light source 11 enters the waveguide 110 from the left end of the waveguide 110 in each drawing, and is emitted from the right end in each drawing. In the following descriptions, among the end portions of the waveguide 110, an end portion (left end in FIG. 2 or 3) at which the light generated from the light source 11 enters may be referred to as an incident end, and an end portion (right end in FIG. 2 or 3) at which the light generated from the light source 11 enters may be referred to as an exit end.

The imaging apparatus 100 reconstructs an image using the compressed sensing technique described above. More specifically, the imaging apparatus 100 reconstruct the image on the basis of the power of light emitted from the waveguide 110, applied to the object, and detected by the detector 120.

In general, when the light emitted from the exit end of the waveguide 110 is applied to an object of some kind, a speckle pattern is generated due to interference or the like. The generated speckle pattern varies depending on the light incident on the waveguide 110. The imaging apparatus 100 uses such a diversity of near-field speckle patterns of light emitted from the waveguide 110 to reconstruct an image on the basis of the compressed sensing technique. By using such a method, it becomes possible to reconstruct an image with less observation data compared with the number of pixels of the image to be reconstructed. In the following descriptions, the speckle pattern generated by light emitted from the exit end of the waveguide 110 may be simply referred to as a speckle pattern.

The speckle pattern will be further described. As described above, the speckle pattern is generated by near-field light emitted from the exit end of the waveguide 110. The direction in which the waveguide 110 extends is defined as a z direction (direction indicated by the solid line arrow in the waveguide 110 in FIGS. 2 and 3), the cross-sectional direction of the waveguide 110 is defined as an x direction (upward direction orthogonal to the solid line arrow in the waveguide 110 in FIGS. 2 and 3), and a direction from the bottom to the top of the drawing is defined as a y direction. It is assumed that a light beam having an angular velocity ω is made incident on the waveguide 110. With respect to the speckle pattern in this case, if the distribution of the optical electric field intensity at the incident end of the waveguide 110 serving as a multimode waveguide is represented by Eᵢₙ and the distribution of the optical electric field intensity at the exit end is represented by Eₒᵤₜ, a relationship between the Eᵢₙ and Eₒᵤₜ can be expressed by the following expression (1).

[Math. 1]

Eₒᵤₜ=Eᵢₙ(x,y)e^{(i(k}^{_{z}}^{z-ωt)} (1)

In the expression (1), and in the expression (1), a wavenumber k_{z} in the z direction is k_{z}=2π/λ*cos α. In the equation expressing k_{z}, α represents an incident angle of incident light, and λ represents a wavelength of the incident light.

That is, assuming that the waveguide 110 serves as a multimode waveguide, the incident light having been made incident on the waveguide 110 excites light of different waveguide modes depending on the incident angle and the like. Furthermore, the incident light is reflected on the inner surface of the waveguide 110 multiple times. For those reasons, the intensity distribution of Eₒᵤₜ, which is emitted light, becomes a pseudo-random distribution, for example. A pseudo-random distribution possesses regularity unlike an inherently random distribution. In addition, the regularity is not immediately apparent in the pseudo-random distribution unlike traditional distribution such as Gaussian distribution and Bernoulli distribution. The pseudo-random distribution of speckles on the fiber exit face can be estimated by tracing incident rays and linearly adding the multiple incident rays.

The intensity distribution of Eₒᵤₜ changes according to the wavelength and the incident angle of the incident light as expressed by the expression (1). That is, the speckle pattern generated by the light emitted from the waveguide 110 changes according to the wavelength and the incident angle of the incident light. In addition, the speckle pattern may also change depending on the wavefront of the incident light (i.e., plane constituted by a collection of points of the same phase).

Accordingly, the imaging apparatus 100 uses a plurality of speckle patterns, which changes when conditions of the incident light including the incident angle, wavelength, wavefront, and the like of the incident light are changed, to reconstruct an image on the basis of an ADMM algorithm. In the following descriptions, to “change the wavefront” means to change the phase of light at the same point.

In the following descriptions, changing conditions of the incident light, such as the incident angle, wavelength, and wavefront of the incident light to be made incident on the waveguide 110, will be called modulation.

Image reconstruction is carried out on the basis of the ADMM algorithm, which is one of techniques of the compressed sensing, using a transformation matrix D obtained according to the speckle pattern. Hereinafter, a procedure for obtaining the transformation matrix D and a procedure for reconstructing an image based on the ADMM algorithm using the transformation matrix D will be described.

The procedure for obtaining the transformation matrix D will be described. For example, the transformation matrix D is obtained using the configuration illustrated in FIG. 3. The number of rows and the number of columns of the transformation matrix D are determined depending on the number of pixels of the image to be reconstructed. Hereinafter, it is assumed that the image to be reconstructed is x, and the image x is an image of m pixels in width and n pixels in length. Hereinafter, the procedure for obtaining the transformation matrix D may be called a calibration process or simply called calibration.

In the configuration illustrated in FIG. 3, the waveguide 110, the light source 11, the modulator 12, the modulation control unit 13, and the optical system 14 are elements similar to those illustrated in FIG. 2. In addition, a camera 18 is provided to face the exit end of the waveguide 110 in FIG. 3. The camera 18 includes, for example, a sensor in which the number of pixels is equal to or more than the number of pixels of the image to be reconstructed by the imaging apparatus 100. The speckle pattern of the near-field light emitted from the exit end of the waveguide 110 is imaged on the sensor surface of the camera 18.

A camera according to the wavelength of light to be generated by the light source 11 is used as the camera 18. In a case where the light to be generated by the light source 11 is visible light, a camera of a general charge coupled device (CCD), a complementary metal-oxide-semiconductor (CMOS) image sensor, or the like is used as the camera 18. Furthermore, as the camera 18, an ultraviolet camera is used when the light is ultraviolet light, an indium gallium arsenide (InGaAs) camera is used in the case of near-infrared light, and a thermal image camera or the like is used in the case of mid/far-infrared light, for example. The arrangement of pixels including the number of pixels and the aspect ratio of the camera 18 is determined depending on the number of pixels and the arrangement of pixels of the image to be reconstructed. The sensitivity characteristic of the camera 18 is preferably close to that of the detector 120.

It is necessary to use the same speckle pattern in both the case of obtaining the transformation matrix D and the case of reconstructing the image. Therefore, the elements same as those of the imaging apparatus 100 using the obtained transformation matrix D are generally used as the elements of the waveguide 110, the light source 11, the modulator 12, and the optical system 14 illustrated in FIG. 3. In addition, the positional relationship at the time of disposing those elements needs to be the same condition as that of the imaging apparatus 100 using the obtained transformation matrix D.

As expressed by the expression (1) mentioned above, the distribution of the speckle pattern changes according to the modulation of the incident light. That is, the speckle pattern generated by the light emitted from the waveguide 110 changes according to the wavelength and the incident angle of the incident light. In addition, the speckle pattern may also vary depending on the wavefront of the incident light. In the following example, the transformation matrix D is obtained on the basis of a plurality of speckle patterns obtained by modulating the conditions of the incident light including the incident angle, wavelength, wavefront, and the like of the incident light.

At the time of obtaining the transformation matrix D, first, the light source 11 generates light, and the modulator 12 modulates the light generated by the light source 11. In the example illustrated in FIG. 3, an exemplary case where the incident angle of the incident light to the waveguide 110 is changed to modulate the incident light is assumed. In this example, the modulator 12 is a galvanometer mirror capable of changing an angle of a reflective surface.

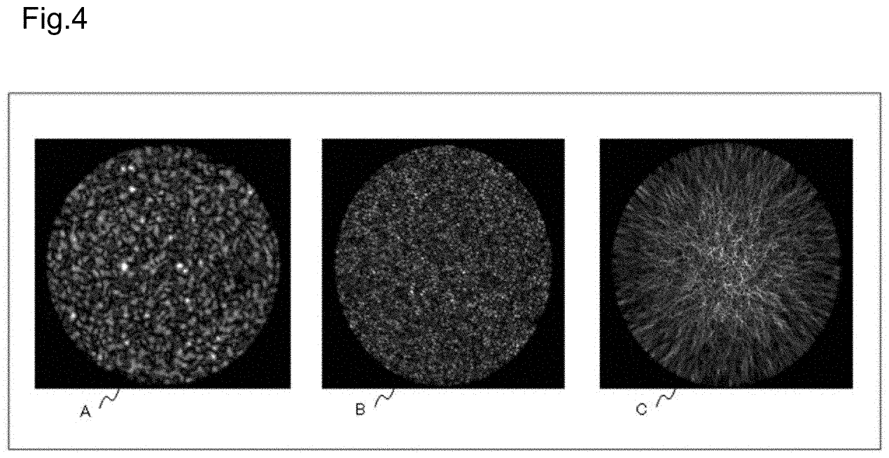

The light modulated by the modulator 12 passes thorough the optical system 14, and enters the waveguide 110. The near-field light emitted from the exit end of the waveguide 110 is imaged on the sensor surface of the camera 18. FIGS. 4A to 4C are exemplary speckle patterns obtained in a case where the incident angle of the incident light to the waveguide 110 is changed.

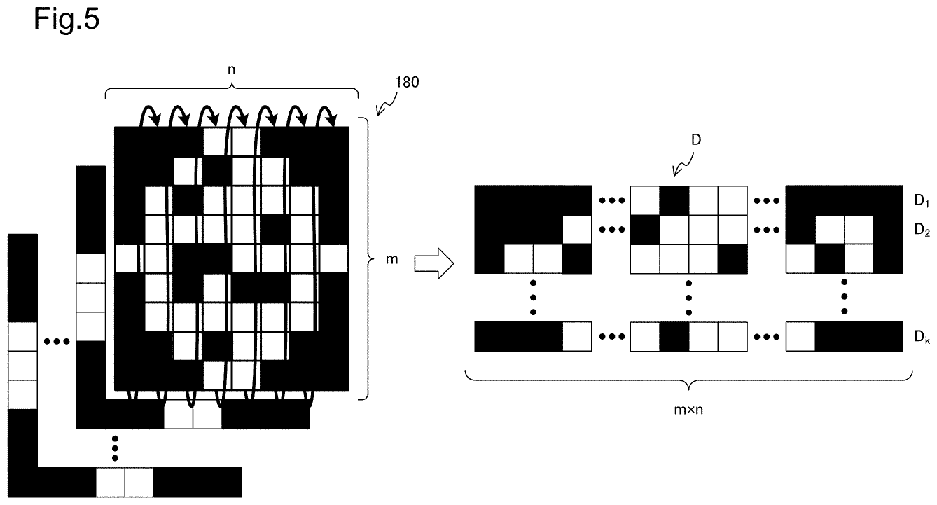

FIG. 5 illustrates a relationship between the transformation matrix D and a speckle pattern 180 detected by the camera 18.

FIG. 5 schematically illustrates an exemplary case where the power of the speckle pattern 180 is detected in two gradations. That is, in the example illustrated in FIG. 5, a region where the power of the speckle pattern 180 is large is represented by a black square, and a region where the power of the speckle pattern 180 is small is represented by a white square for each pixel of the camera 18.

The power of the speckle pattern 180 for each pixel detected by the camera 18 is expressed as an m×n dimensional vector Di (i=1, 2, . . . , k) relevant to the number of pixels (m×n) of the image to be reconstructed. Therefore, in the exemplary transformation matrix D illustrated in FIG. 5, the power of the speckle pattern 180 detected by the camera 18 is expressed as an m×n dimensional vector. The power of the speckle pattern 180 may be detected in multiple gradations depending on, for example, sensitivity resolution of the detector 120.

Such detection of the speckle pattern 180 by the camera 18 is repeated for different speckle patterns 180 as illustrated in FIGS. 4A to 4C. As described above, the speckle pattern 180 changes by the incident light to the waveguide 110 being modulated. For example, in a case where the modulator 12 is a galvanometer mirror, which is one of mechanisms for changing a reflection angle of reflected light, the speckle pattern 180 changes by light being made incident on the waveguide 110 at different incident angles.

Therefore, observation of such different speckle patterns 180 is carried out using the camera 18 while changing the state of modulation by the modulator 12.

FIG. 5 schematically illustrates an exemplary case where the speckle pattern 180 is changed. In the repeated detection of the speckle pattern 180, a plurality of vectors is obtained from the power of the signal for each pixel detected by the camera 18. Vectors D₁ to Dₖ of the number of k obtained by observations of the different speckle patterns 180 of k times constitute the transformation matrix D. That is, each row of the transformation matrix D is an m×n dimensional vector Dᵢ (1≤i≤k) obtained for one speckle pattern 180.

The number of observations (k) of the speckle pattern 180 may be determined appropriately depending on conditions such as image quality required for the image to be reconstructed and a type of the modulator 12 or the detector 120.

Next, a procedure for reconstructing an image using the transformation matrix D will be described. Image reconstruction is carried out on the basis of the ADMM algorithm. As described above, the image x to be reconstructed is assumed to be an image of m pixels in width and n pixels in length.

In the imaging apparatus 100, an image is reconstructed using a plurality of total sums of power of the speckle patterns generated when light from the light source 11 is made incident on the waveguide 110 and imaged on the target.

As described above, it is necessary to use the same speckle pattern in both the case of obtaining the transformation matrix D and the case of reconstructing the image. Accordingly, the modulator 12 is controlled by the modulation control unit 13 in such a manner that the same speckle pattern is generated in both the case of obtaining the transformation matrix D and the case of reconstructing the image. In both the case of obtaining the transformation matrix D and the case of reconstructing the image, observation is carried out the same number of times, which is k times.

In the present example embodiment, it is assumed that the detector 120 detects only the power of the speckle pattern applied to the target 17 without detecting positional information such as power distribution of the speckle pattern. Therefore, the total sum of power detected by the detector 120 is the sum of signal intensity of all the pixels of the image to be reconstructed.

In this case, power jᵢ of the signal to be detected by the detector 120 with respect to the speckle pattern relevant to the vector Dᵢ constituting any row of the transformation matrix D for the image x to be reconstructed by the imaging apparatus 100 is expressed by the following expression (2).

$$[ Math . 2 ]$$

$${j}_{i} = {\sum }_{k = 1}^{m * n} {d}_{k}^{i} * {x}_{k} \qquad ( 2 )$$

In the expression (2), dⁱₖ represents one of the m×n elements included in the vector Dᵢ described above (see the transformation matrix D in FIG. 5), and xₖ represents a value obtained by sequentially arranging a value representing the signal intensity of each of the m×n pixels included in the image x. Values of dⁱₖ and xₖ represent values at relevant positions in the image.

It is assumed that power of a signal is detected by the detector 120 for speckle patterns of the number of k relevant to D₁ to Dₖ. In this case, the relationship of the following expression (3) is obtained with respect to vector j_{k×1}=(j₁, j₂, . . . , jₖ) of the power jᵢ (i=1 to k) of the k signals detected for D₁ to Dₖ.

[Math. 3]

D_{k×mn}×x_{mn×1}=j_{k×1} (3)

In the expression (3), the superscript in each of D_{k×mn}, x_{mn×1}, and j_{k×1} indicates the number of elements of the matrix representing each value. D_{k×mn} represents a transformation matrix of k rows and (m×n) columns. That is, the transformation matrix D_{k×mn} is composed of k vectors Dᵢ (i=1 to k) each containing (m×n) elements. A vector of (m×n) rows is represented by x_{mn×1}. A vector of k rows is represented by j_{k×1}. In the following descriptions, D, x, and j without subscripts represent the contents same as D_{k×mn}, x_{mn×1}, and j_{k×1}, respectively.

In the compressed sensing, a solution to the minimization problem expressed by the following expression (4) is obtained to reconstruct the image. That is, by obtaining the L1 norm solution of the expression (4), the image x is reconstructed from the detection results of the power of the k signals described above.

[Math. 4]

min∥x∥ₓs.t. j=Dx (4)

In the expression (4), ∥x∥₁ represents the L1 norm of x.

The solution to the expression (4) mentioned above is obtained according to the procedure to be described below using the ADMM algorithm. First, a cost function represented by the following expression (5) is considered.

[Math. 5]

L(x)=∥x∥₁+v^{T}(j−Dx) (5)

The expression (5) is a cost function associated with the method of Lagrange multiplier. In the expression (5), v represents a Lagrange undetermined multiplier.

In the expression (4), a new variable z is introduced to distinguish x for the L1 norm from another x. The problem of minimizing the L(x) expressed in the expression (5) is replaced with the conditional minimization problem expressed in the following expression (6). In the expression (6), λ represents a cost coefficient associated with the method of Lagrange multiplier.

$$[ Math . 6 ]$$

$${min}_{x , z} \{ {‖ z ‖}_{1} + \frac{1}{2 λ} {‖ j - Dx ‖}_{2}^{2} \} s . t . z - j = 0 \qquad ( 6 )$$

According to the procedure of the augmented Lagrangian method, a new cost function expressed in the following expression (7) is minimized.

$$[ Math . 7 ]$$

$${L}_{aug} . ( x , z ; u [ t ] ) = {‖ z ‖}_{1} + {v}^{T} ( j - Dx ) + \frac{μ}{2} {‖ x - z + u [ t ] ‖}_{2}^{2} \qquad ( 7 )$$

In the expression (7), u[t] represents an auxiliary term for conversion to the optimum solution when the constrained optimization problem is solved by a gradient method for performing iterative calculation from an appropriate initial point. The following expression (8) is obtained by differentiating the expression (7) with respect to x.

[Math. 8]

∇ₓL_{aug}·(x, z; u[t])=−D^{T}v+μ(x−z+u[t]) (8)

Assuming that x is a value with which the expression (8) is zero, the following expression (9) is obtained.

$$[ Math . 9 ]$$

$$x = \frac{1}{μ} {D}^{T} v + ( z - u [ t ] ) \qquad ( 9 )$$

By substituting x obtained in the expression (9) into the cost function of the original expression (7), the expression (7) becomes the following expression (10).

$$[ Math . 10 ]$$

$${L}_{aug} . ( x , z ; u [ t ] ) = {‖ z ‖}_{1} + {v}^{T} ( j - D ( z - u [ t ] ) ) - \frac{1}{2 μ} {‖ {D}^{T} v ‖}_{2}^{2} \qquad ( 10 )$$

The expression (10) can be considered to be a quadratic function with respect to v. Accordingly, the optimum solution by which the expression (10) is maximized is expressed by the following expression (11).

[Math. 11]

v=μ(DD^{T})⁻¹[j−D(z−u[t])] (11)

By substituting the obtained expression (11) into the expression (9), the following expression (12) is obtained.

[Math. 12]

x=D^{T}(DD^{T})⁻¹j+(I−D^{T}(D^{T}D)⁻¹D)(z−u[t]) (12)

A expression (13) is obtained by the gradient method using iterative calculation described above. When the gradient method is applied to the expression (12), the following three expressione (13) are obtained as expressione representing a t+1 value of the iterative calculation for x, z, and u.

[Math. 13]

x[t+1]=D^{T}(D^{T}D)⁻¹j+(I−D^{T}(D^{T}D)⁻¹D)(z[t]−u[t])

z[t+1]=W_{1/μ}(x[t+1]+u[t])

u[t+1]=u[t]+(x[t+1]−z[t+1]) (13)

where

$${W}_{1 \text{/} μ} ( x ) = \{ \begin{matrix}x - \frac{1}{μ} ( x > \frac{1}{μ} ) \\ 0 ( - \frac{1}{μ} ≦ x ≦ \frac{1}{μ} ) \\ x + \frac{1}{μ} ( x < - \frac{1}{μ} )\end{matrix} \}$$

In the present example embodiment, it is assumed that the iterative calculation is performed only once. In this case, z[t+1] and u[t+1] do not need to be considered. While z[t] and u[t] need to be initialized, z[0] and u[0] may be zero. Accordingly, the following expression (14) is obtained as the image x to be reconstructed.

[Math. 14]

x[1]=D^{T}(DD^{T})⁻¹j (14)

Meanwhile, the ADMM algorithm exerts a great effect in the case where a base expected to be sparse is found through a certain transformation. A sparse property of a signal indicates a property in which a number of components of the signal are zero. Accordingly, it is generally necessary to convert x into a space having sparsity when reconstructing the image x. That is, the image is reconstructed in a space having sparsity.

Sparsification is achieved by, for example, performing a discrete Fourier transform or a wavelet transform on the image x. Accordingly, as expressed by the following expression (15), the image x is made sparse using a sparse transformation matrix Φ. The sparse transformation matrix Φ is, for example, either a discrete Fourier transformation matrix or a wavelet transformation matrix. Then, Q is obtained on the basis of the ADMM algorithm described above.

[Math. 15]

Φ·x_{mn×1}=Q_{mn×1} (15)

The expression (15) is converted into the form expressed by the following expression (16) using an inverse matrix Φ⁻¹ of the transformation matrix Φ.

[Math. 16]

Φ⁻¹·Q_{mn×1}=x_{mn×1} (16)

The expression (16) is further converted into the form expressed by the following expression (17) using the relationship expressed by the expression (3).

[Math. 17]

D′_{k×mn}·Φ⁻¹·Q_{mn×1}=j_{k×1} (17)

In a case where the sparse transformation matrix Φ is the discrete Fourier transform or the wavelet transformation matrix, a conjugate transposed matrix of Φ is expressed by the subscript “+”, and when expressed as Φ⁺, Φ and Φ⁺ are inverse matrixes of each other.

Accordingly, the following expression (18) is obtained from the expression (17).

[Math. 18]

D′_{mn×1}·Φ⁺·Q_{mn×1}=j_{k×1} (18)

In the expression (18), an unknown is Q. Accordingly, an approximate solution Q″ of Q is obtained by obtaining the minimum solution of the L1 norm as expressed by the following expression (19).

[Math. 19]

Q″_{mn×1}=argmin∥Q_{mn×1}∥₁ s.t.D′_{k×mn}+Φ⁺Q_{mn×1}=j_{k×1} (19)

In a similar manner to the example of obtaining the expression (17) with respect to the expression (4) described above, the following expression (20) is obtained with respect to the expression (19).

[Math. 20]

Q″_{mn×1}[1]=(D′_{k×mn}·Φ⁺)⁺·inv[(D′_{k×mn}·Φ⁺)·(D′_{k×mn}·Φ⁺)⁺]·j_{k×1}=P·j (20)

In the expression (20), P represents (D′_{k×mn}Φ⁺)⁺inv[(D′_{k×mn}Φ⁺)(D′_{k×mn}Φ⁺)⁺]. In addition, j on the right side of the expression (20) represents the content same as j_{k×1} on the left side.

That is, Q″, which is the approximate solution of Q, is obtained, and the obtained Q″ and Φ⁺ described above are used to obtain the image x to be reconstructed.

The number of observations k performed by the camera 18 or the detector 120 may be generally smaller than m×n, which is the number of pixels of the image x to be reconstructed. For example, in a case where the sparsification described above is properly performed, the number of observations k by the camera 18 or the detector 120 may be at about several percent of the number of pixels. That is, the imaging apparatus 100 uses the ADMM algorithm, which is a method of compressed sensing, to enable image reconstruction from a small amount of data obtained by changing the speckle pattern.

The number of observations k by the camera 18 or the detector 120 is not limited to the example described above, and may be appropriately determined depending on the degree of sparsification or the image quality required for the image to be reconstructed.

Next, each element of the imaging apparatus 100 according to the present example embodiment will be described in detail.

The light source 11 generates light to be applied to the object. In the present example embodiment, the light source 11 is a light source that primarily generates light of a desired single wavelength. It is sufficient if conditions such as intensity and a wavelength of light to be generated by the light source 11 are appropriately determined depending on a target to be a subject of an image and other factors. The light source 11 may be a white light source that generates light of various wavelengths, or may be capable of changing a wavelength of light to be generated, such as a wavelength-tunable laser. A specific type and the like of the light source 11 is not particularly limited, and it is sufficient if desired light can be generated.

The modulator 12 modulates the light generated by the light source 11. As described above, the light generated from the light source 11 is modulated by, for example, changing the wavefront, the wavelength, or the incident angle to the waveguide 110. Accordingly, the modulator 12 changes those. That is, the modulator 12 changes either the incident angle of the light generated from the light source to the waveguide, the wavefront of the light generated from the light source, or the wavelength of the light generated from the light source, for example.

In a case where the modulator 12 changes the incident angle of the light generated from the light source 11 to the waveguide 110, a mechanism for changing the traveling direction of the light, such as a galvanometer mirror, a piezoelectric element mirror, and a movable stage, is used as the modulator 12. In a case where the modulator 12 changes the wavefront of the light generated from the light source 11, a mechanism for changing the wavefront of the light, such as an optical space modulator, a digital mirror device, and a shape-variable mirror, is used as the modulator 12.

Furthermore, in a case where the modulator 12 changes the wavelength of the light generated from the light source 11, a white light source is used as the light source 11 when the modulator 12 is a mechanism for changing the wavelength of the light generated from the light source 11 for extracting light of a specific wavelength such as a diffraction grating and a prism. In this case, instead of the modulator 12, the light source 11 may have a mechanism capable of changing the wavelength of light to be generated, such as the wavelength-tunable laser mentioned above.

The modulation control unit 13 controls a state of modulation by the modulator 12. For example, in a case where the modulator 12 is a galvanometer mirror, the modulation control unit 13 changes the orientation of the mirror surface to perform control to change the incident angle of the incident light generated from the light source 11 and made incident on the waveguide 110. Even in a case where another mechanism is used as the modulator 12, it is sufficient if the modulation control unit 13 appropriately controls the modulator 12 in such a manner that the light generated from the light source 11 is modulated.

As described above, it is necessary to use the same speckle pattern in both the case of obtaining the transformation matrix D and the case of reconstructing the image. Accordingly, the same light source 11 and the modulator 12 are generally used in both the case of obtaining the transformation matrix D and the case of reconstructing the image. The modulation control unit 13 controls the modulator 12 in such a manner that the modulation by the modulator 12 is performed under the same condition in both the case of obtaining the transformation matrix D and the case of reconstructing the image.

The beam splitter 15 separates the light to be made incident on the waveguide 110 and travel toward the target from the light obtained from the object. In the example illustrated in FIG. 2, the beam splitter 15 is provided in such a manner that the light to be made incident on the waveguide 110 is allowed to pass and the light reflected by the target and traveling toward the detector is separated.

In the example illustrated in FIG. 2, the detector 120 is configured to detect the reflected light of the speckle pattern from the target. However, as described later, the detector 120 may detect the transmitted light of the speckle pattern transmitted through the target depending on an application purpose of the imaging apparatus 100. In this case, the detector 120 is disposed at a position opposite to the position at which the waveguide 110 is disposed with respect to the target 17. In other words, in this case, the target 17 is disposed between the exit end of the waveguide 110 and the detector 120. Accordingly, in this case, the beam splitter 15 is not required.

That is, it is sufficient if the beam splitter 15 is provided when necessary depending on conditions for reconstructing the image, such as a type of the target.

The waveguide 110 transmits light generated from the light source. In the present example embodiment, a multimode waveguide is used as the waveguide 110. With the multimode waveguide being used, it becomes possible to obtain different speckle patterns according to modulation of light incident on the waveguide 110.

For example, a multimode optical fiber, a rectangular or circular waveguide, or a photonic crystal waveguide is used as the waveguide 110. Other types of optical waveguides may be used as the waveguide 110 as long as different speckle patterns can be obtained depending on a degree of modulation of light incident on the waveguide 110.

Furthermore, when the waveguide 110 having a large number of modes is used, an information volume increases, and resolution can be improved. Accordingly, it is preferable to use the waveguide 110 having a large diameter within the realm of availability.

As described above, the detector 120 detects the power of the speckle pattern of the near-field light emitted from the waveguide 110 and applied to the target.

In the present example embodiment, the detector 120 detects the power of the speckle pattern. That is, the detector 120 is not necessarily detect positional information such as power distribution of the speckle pattern. The detector 120 may be any one-pixel sensor, and is not necessarily a detector that detects power positional information, such as sensors arranged in an array. The imaging apparatus 100 makes it possible to obtain a two-dimensional image without using, for example, sensors arranged in an array, which may be expensive depending on a wavelength band or the like to be detected.

A general detector capable of detecting the power of the speckle pattern is appropriately used as the detector 120 depending on the wavelength of light to be generated by the light source 11 and other conditions. A camera including a CCD camera or a CMOS image sensor, an ultraviolet camera, an InGaAs camera, a thermal image camera, or the like is appropriately used as the detector 120 depending on conditions such as a wavelength of light to be generated by the light source 11.

Gradation of the power magnitude of the signal that can be detected by the detector 120 is not particularly limited. In a case where sensitivity resolution of the detector 120 is high, that is, the power of the signal is detected by the detector 120 in a larger number of gradations, it becomes possible to reconstruct an image with less noise.

In the example illustrated in FIG. 2, as described above, the detector 120 detects the power of the speckle pattern applied to and reflected by the target 17. That is, a speckle emitted from the waveguide 110 is imaged on the target 17 spaced apart from the lens probe 16 by the lens probe 16 provided at the exit end of the waveguide 110. The detector 120 detects the power of the light reflected from the target 17 and transmitted through the lens probe 16, waveguide 110, and the beam splitter 15.

However, the detection of the power by the detector 120 may be carried out under conditions different from those in the example illustrated in FIG. 2. For example, the waveguide 110 or the lens probe 16 may be in intimate contact with the target 17. Furthermore, the detector 120 may detect the power of the speckle pattern transmitted through the target 17. That is, conditions for the detection by the detector 120, including a positional relationship with the waveguide 110 and the like, are not particularly limited as long as the power of the speckle pattern reflected from the target or the speckle pattern transmitted through the target can be detected.

Furthermore, as illustrated in FIGS. 2 and 3, the positional relationship between the detector 120 and other elements may be different from or the same as the positional relationship between the camera 18 and other elements in the case of obtaining the transformation matrix D.

The reconstruction unit 130 reconstructs an image using the transformation matrix D obtained in advance as described above on the basis of the power of a plurality of speckle patterns generated by the light modulated by the modulator 12 and detected by the detector 120.

More specifically, the reconstruction unit 130 obtains Q using the relationship of the expression (19) mentioned above on the basis of the power of the signal obtained by the observation of k times performed by the detector 120. As described above, Q is a value obtained by performing the discrete Fourier transform or the wavelet transform on the image x. After Q is obtained, the reconstruction unit 130 reconstructs the image using the inverse matrix Φ⁻¹ of the transformation matrix Φ. In the present example embodiment, it is assumed that the image to be reconstructed in this case is a monochromatic image.

The reconstruction unit 130 is implemented by, for example, appropriately combining hardware including a central processing unit (CPU) and a memory and software for reconstructing an image. A specific configuration of the reconstruction unit 130 is not particularly limited, and may be implemented by, for example, a field programmable gate array (FPGA) or dedicated hardware. The reconstruction unit 130 may have a function of obtaining the transformation matrix D through the procedure of the calibration process described above.

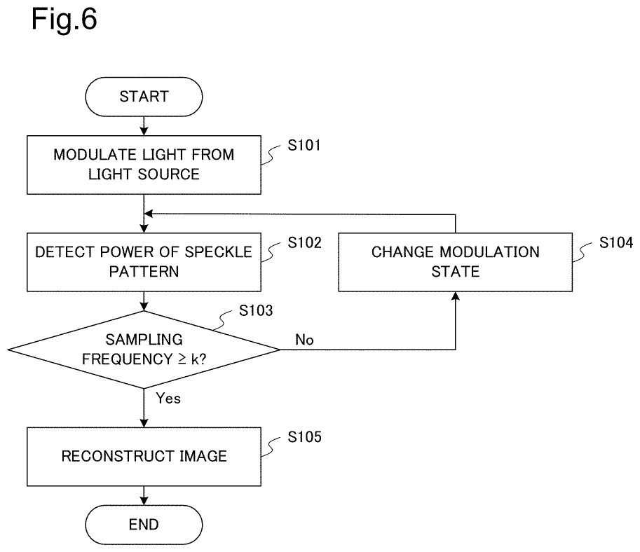

Next, exemplary operation of the imaging apparatus 100 will be described with reference to the flowchart illustrated in FIG. 6. In the following descriptions of the operation, it is assumed that the transformation matrix D is obtained in advance with respect to the speckle pattern of the waveguide 110 through the procedure of the calibration process described above.

First, the light generated by the light source 11 passes through the waveguide 110 and irradiates the target 17 (step S101).

The detector 120 detects the power of the speckle pattern generated by the light from the light source 11 irradiating the target 17 (step S102).

Next, the reconstruction unit 130 determines whether the power is observed in step S102 k times, which is the predetermined number of observations (step S103). If the number of observations does not reach the predetermined number (No in step S103), for example, the modulation control unit 13 changes the state of modulation performed by the modulator 12 in such a manner that the speckle pattern changes (step S104). In this case, the state of modulation performed by the modulator 12 is controlled in such a manner that the speckle pattern similar to the case of obtaining the transformation matrix D is generated. Returning to step S102, the detector 120 detects the power of the speckle pattern.

If the number of observations has reached the predetermined number (Yes in step S103), the reconstruction unit 130 reconstructs an image (step S105). That is, in step S102, the reconstruction unit 130 reconstructs the image using the transformation matrix D obtained in advance on the basis of the power of the speckle pattern observed by the detector 120 k times.

As described above, the imaging apparatus 100 according to the present example embodiment reconstructs the image using the ADMM algorithm that is one of techniques of the compressed sensing. Various speckle patterns generated by the waveguide 110 are used in the image reconstruction.

A type of the waveguide 110 is not particularly limited as long as it is a multimode waveguide. That is, it is possible to reconstruct an image using a common waveguide 110 having a small diameter such as a micrometer-order single waveguide 110. Therefore, the imaging apparatus 100 serves as an imaging apparatus usable in a narrow space.

Furthermore, according to the imaging apparatus 100, the resolution in reconstruction can be increased by obtaining the transformation matrix D relevant to a larger number of speckle patterns and carrying out a larger number of observations relevant to the speckle patterns. That is, by using the imaging apparatus 100, it becomes possible to obtain an image with a resolution relevant to an application purpose without depending on the diameter of the waveguide.

(Variations)

Variations of the imaging apparatus 100 described above are conceivable.

In the imaging apparatus 100, the light source 11 for generating light of a single wavelength is used. That is, according to the imaging apparatus 100, a monochromatic image is reconstructed for a specific wavelength. However, the imaging apparatus 100 may be what is called a multicolor apparatus, that is, an apparatus that reconstructs images for a plurality of wavelengths.

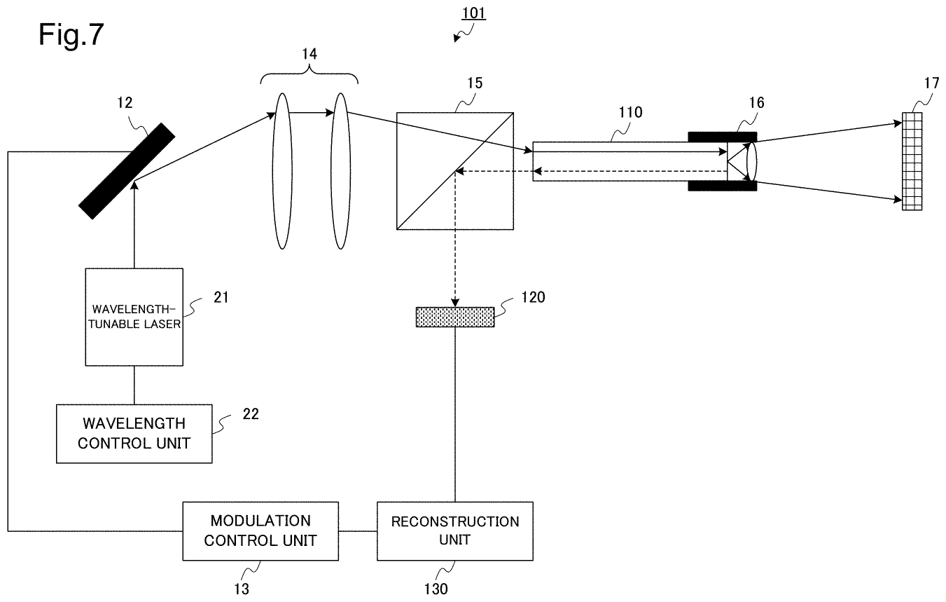

Each of FIGS. 7 to 10 illustrates an exemplary configuration in the case where the imaging apparatus 100 reconstructs images for a plurality of wavelengths.

In the example illustrated in FIG. 7, an imaging apparatus 101 includes a wavelength-tunable laser 21 and a wavelength control unit 22 instead of the light source 11 of the imaging apparatus 100. The wavelength-tunable laser 21 generates laser light having a wavelength under the control of the wavelength control unit 22. A wavelength range of the laser light that can be generated by the wavelength-tunable laser 21 is not particularly limited. It is sufficient if an appropriate wavelength-tunable laser 21 is used depending on, for example, conditions required for an image to be reconstructed.

In the imaging apparatus 101, the wavelength control unit 22 performs control in such a manner that the wavelength-tunable laser 21 generates laser light having a specific wavelength. An image for the specific wavelength is then reconstructed. Subsequently, the wavelength control unit 22 performs control in such a manner that the wavelength of the laser light generated by the wavelength-tunable laser 21 changes, and an image for a different wavelength is reconstructed.

A transformation matrix D to be used in reconstructing an image is different for each wavelength. Accordingly, the transformation matrix D is obtained in advance for each wavelength. When reconstructing an image, the transformation matrix D relevant to the wavelength is used. Images for multiple wavelengths are reconstructed by repeatedly reconstructing images for different wavelengths.

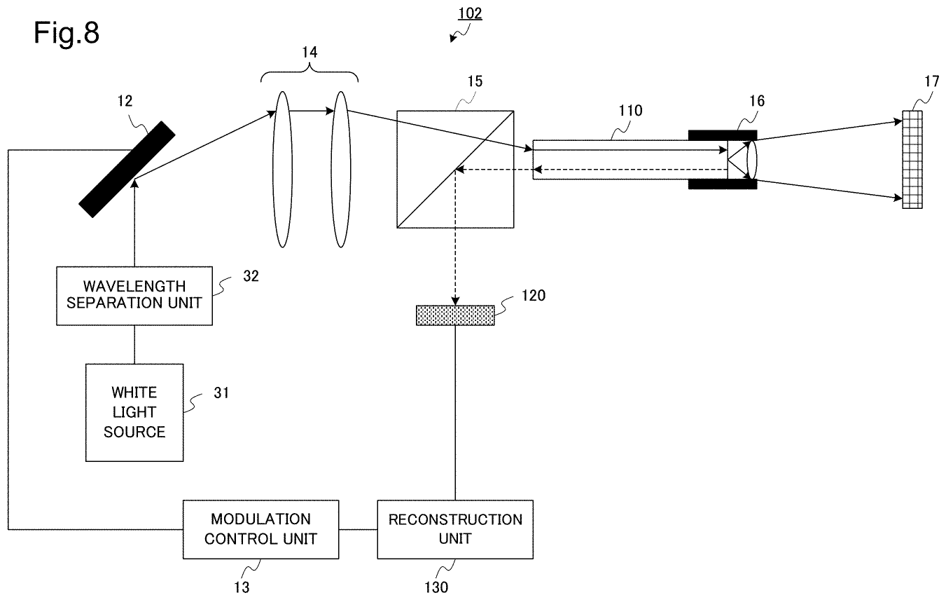

In the example illustrated in FIG. 8, an imaging apparatus 102 includes a white light source 31 instead of the light source 11 of the imaging apparatus 100. The imaging apparatus 102 further includes a wavelength separation unit 32.

The white light source 31 is a light source that generates light of various wavelengths. In the present variation, a spectral distribution of light emitted from the white light source 31 is not particularly limited, and the range of the spectral distribution and the intensity of the light of each wavelength may not be uniform. In the present variation, it is sufficient if a light source that emits light of a wavelength required to reconstruct an image is appropriately used as the white light source 31 depending on, for example, conditions required for the image to be reconstructed. That is, the white light source 31 may be any light source that generates light of a plurality of wavelengths required to reconstruct an image.

The wavelength separation unit 32 separates the light generated by the white light source 31 for each wavelength. That is, the wavelength separation unit 32 serves as a mechanism for extracting separation of a desired wavelength from the light generated by the white light source 31. While a diffraction grating, a prism, a filter, an electro-optic crystal, an acousto-optic crystal, or a magneto-optic crystal is used as the wavelength separation unit 32, for example, another mechanism for separating white light for each wavelength may be used. In addition, the wavelength separation unit 32 is also provided with a mechanism for extracting monochromatic light of a specific wavelength.

According to the imaging apparatus 102, the light of a specific wavelength separated by the wavelength separation unit 32 is made incident on the waveguide 110 to reconstruct an image. Then, the wavelength of the light to be made incident on the waveguide 110 is changed to reconstruct an image, thereby reconstructing images for multiple wavelengths in a similar manner to the imaging apparatus 101.

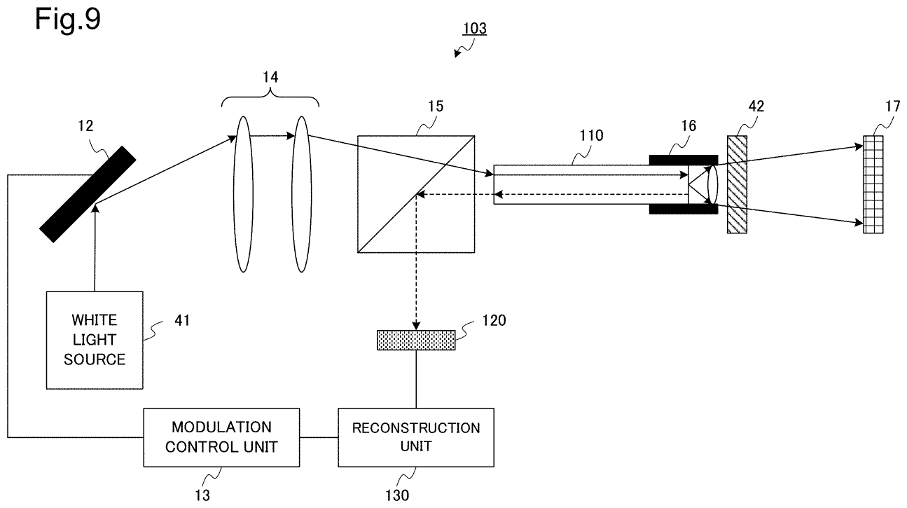

In the example illustrated in FIG. 9, an imaging apparatus 103 includes a white light source 41 instead of the light source 11 of the imaging apparatus 100. The imaging apparatus 103 further includes a filter 42.

The white light source 41 is a light source similar to the white light source 31 described above. The filter 42 is a filter that transmits light of a specific wavelength. That is, in a similar manner to the wavelength separation unit 32 described above, the filter 42 is a mechanism for extracting separation of a desired wavelength from the light generated by the white light source 41, and can be said that another implementation example of the wavelength separation unit 32.

For example, multiple filters having different wavelengths of light to be transmitted depending on the image to be reconstructed are used as the filter 42. The filter 42 may be a filter that varies the wavelength of light to be transmitted.

In the imaging apparatus 103, the filter 42 transmits light of a specific wavelength, thereby reconstructing an image for the specific wavelength. Then, the filter 42 that transmits light of a different wavelength is used or the filter 42 changes the wavelength of light to be transmitted, thereby reconstructing images for multiple wavelengths in a similar manner to the imaging apparatus 101 and the like.

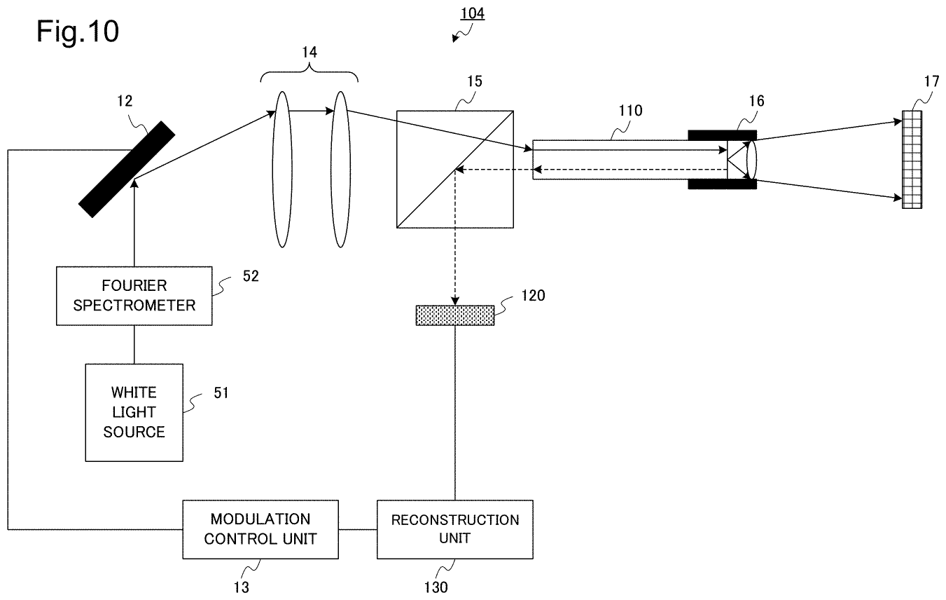

In the example illustrated in FIG. 10, an imaging apparatus 104 includes a white light source 51 and a Fourier spectrometer 52 instead of the light source 11 of the imaging apparatus 100. The white light source 51 is a light source similar to the white light source 31 and the like described above. For example, a Michelson interferometer is used as the Fourier spectrometer 52.

In the imaging apparatus 104, light of different wavelengths is made incident on the waveguide 110 every prescribed time by the Fourier spectrometer 52. A detection result by the detector 120 is subject to a Fourier transform every prescribed time, thereby obtaining a detection result of light of a specific wavelength. It becomes possible to reconstruct images for multiple wavelengths by using a transformation matrix D or other parameters according to the wavelength.

In each of the imaging apparatuses 101 to 104, the detector 120 is a detector capable of detecting light having a wavelength for an image to be reconstructed. In addition, in each of the imaging apparatuses 101 to 104, the detector 120 is assumed to be a modulator that changes an incident angle of light generated from the light source 11 to the waveguide 110 or a modulator that changes a wavefront of light generated from the light source 11.

Each of the imaging apparatuses 101 to 104 enables reconstruction of images for multiple wavelengths. In other words, each of the imaging apparatuses 101 to 104 enables hyperspectral imaging.

(Simulation Example)
It was confirmed by simulation that an image is reconstructed by the imaging apparatus 100 described above.

The image to be reconstructed was set to an image of 128 pixels in both width and length. A multimode fiber having a diameter of equal to or more than 125 μm (micrometer) was used as the waveguide 110. The light source 11 was set to a light source that emits light of 632.8 nm (nanometer), and the modulator 12 that changes the incident angle to the waveguide 110 was used as the modulator 12.

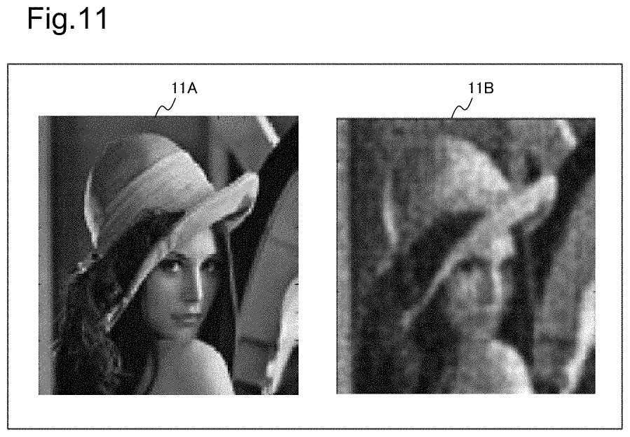

Under those conditions, FIG. 11 illustrates an original image and an image reconstructed when 10% (percent) of the number of pixels of the original image is sampled. As illustrated in FIG. 11, comparing an original image 11A with a reconstructed image 11B, it was confirmed that the outline of the person, variations of light and shade of the original image 11A, and a part of the accessories of the hat were restored in the reconstructed image 11B.

As described above, in this example, a micrometer-order waveguide 110 is used. That is, it was confirmed that the imaging apparatus 100 is capable of performing imaging in a very narrow space.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. The configurations of the example embodiments may be combined with each other without departing from the scope of the present invention.

Although a part or all of the present invention is expressed as the following supplementary notes, it is not limited thereto.

(Supplementary Note 1)

An imaging apparatus including:

a waveguide that transmits light emitted from a light source;

a detector that detects power of a speckle pattern generated by the light passing through the waveguide and applied to an object; and

reconstruction means for reconstructing an image of the object on the basis of the power obtained by making the light enter the waveguide under different conditions.

(Supplementary Note 2)

The imaging apparatus according to Supplementary Note 1, further including:

a modulator that changes the conditions under which the light enters the waveguide.

(Supplementary Note 3)

The imaging apparatus according to Supplementary Note 2, wherein

the modulator changes the conditions by changing an incident angle of the light on the waveguide.

(Supplementary Note 4)

The imaging apparatus according to Supplementary Note 2, wherein

the modulator changes the conditions by changing a wavefront of the light.

(Supplementary Note 5)

The imaging apparatus according to Supplementary Note 2, wherein

the waveguide is a multimode waveguide.

(Supplementary Note 6)

The imaging apparatus according to any one of Supplementary Notes 1 to 5, wherein

the waveguide is a multimode waveguide.

(Supplementary Note 7)

The imaging apparatus according to any one of Supplementary Notes 1 to 6, wherein

the reconstruction means reconstructs the image on the basis of an alternating direction method of multipliers (ADMM) algorithm.

(Supplementary Note 8)

The imaging apparatus according to Supplementary Note 7, wherein

the reconstruction means reconstructs the image on the basis of the ADMM by using a transformation matrix obtained for the conditions and a speckle pattern generated under the conditions.

(Supplementary Note 9)

The imaging apparatus according to any one of Supplementary Notes 1 to 8, further including:

the light source that generates the light of a plurality of wavelengths; and

wavelength separation means for separating the light generated by the light source regarding the plurality of wavelengths, wherein

the reconstruction means reconstructs the image concerning the light for each of the plurality of wavelengths on the basis of the power of the light, the power being detected for each of the plurality of wavelengths.

(Supplementary Note 10)

The imaging apparatus according to any one of Supplementary Notes 1 to 8, further including:

the light source capable of generating light of a selected wavelength among a plurality of wavelengths; and

wavelength control means for controlling a wavelength of the light generated from the light source, wherein

the reconstruction means reconstructs the image concerning the light for each of the plurality of wavelengths on the basis of the power of the light, the power being detected for each of the plurality of wavelengths.

(Supplementary Note 11)

An imaging method including:

detecting power of a speckle pattern generated by light passing through a waveguide and applied to an object; and

reconstructing an image of the object on the basis of the power obtained by making the light enter the waveguide under different conditions.

This application is based upon and claims the benefit of priority from Japanese Patent Application No. 2018-052223, filed on Mar. 20, 2018, the disclosure of which is incorporated herein in its entirety by reference.

### REFERENCE SIGNS LIST

100, 101, 102, 103, 104 imaging apparatus
110 waveguide
120 detector
130 reconstruction unit
11 light source
12 modulator
13 modulation control unit
14 optical system
15 beam splitter
16 lens probe
17 target
18 camera

1. An imaging apparatus comprising:
a waveguide that transmits light emitted from a light source;
a detector that detects power of a speckle pattern generated by the light passing through the waveguide and applied to an object;
at least one memory storing a set of instructions; and
at least one processor configured to execute the set of instructions to
reconstruct an image of the object based on the power obtained by making the light enter the waveguide under different conditions.

2. The imaging apparatus according to claim 1, further comprising
a modulator that changes the conditions under which the light enters the waveguide.

3. The imaging apparatus according to claim 2, wherein
the modulator changes the conditions by changing an incident angle of the light on the waveguide.

4. The imaging apparatus according to claim 2, wherein
the modulator changes the conditions by changing a wavefront of the light.

5. The imaging apparatus according to claim 1, wherein
the waveguide is a multimode waveguide.

6. The imaging apparatus according to claim 1, wherein
the at least one processor is configured to execute the set of instructions to
reconstruct the image based on an alternating direction method of multipliers (ADMM) algorithm.

7. The imaging apparatus according to claim 6, wherein
the at least one processor is configured to execute the set of instructions to
reconstruct the image based on the ADMM algorithm by using a transformation matrix obtained for the conditions and a speckle pattern generated under the conditions.

8. The imaging apparatus according to claim 1, wherein
the light source generates the light of a plurality of wavelengths, and
the at least one processor is configured to execute the set of instructions to:
separate the light generated by the light source regarding the plurality of wavelengths; and
reconstruct the image concerning the light for each of the plurality of wavelengths based on the power of the light, the power being detected for each of the plurality of wavelengths.

9. The imaging apparatus according to claim 1, wherein
the light source is capable of generating light of a selected wavelength among a plurality of wavelengths, and
the at least one processor is configured to execute the set of instructions to:
control a wavelength of the light generated from the light source; and
reconstruct the image concerning the light for each of the plurality of wavelengths based on the power of the light, the power being detected for each of the plurality of wavelengths.

10. The imaging apparatus according to claim 2, wherein
the modulator changes the conditions by changing a wavelength of the light.

11. An imaging method comprising:
detecting power of a speckle pattern generated by light passing through a waveguide and applied to an object; and
reconstructing an image of the object based on the power obtained by making the light enter the waveguide under different conditions.
